(19) United States
(12) Patent Application Publication
(10) Pub. No.: US 2008/0088781 A1
(43) Pub. Date: Apr. 17, 2008

(54) METHOD AND APPARATUS FOR PRINTING ALIGNMENT LAYER OF LIQUID CRYSTAL DISPLAY

(75) Inventors: Jin-Soo JUNG, Goyang-si (KR); Baek-Kyun JEON, Yongin-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/771,200

(22) Filed: Jun. 29, 2007

(30) Foreign Application Priority Data
Oct. 12, 2006 (KR) 10-2006-0099525

(51) Int. Cl. G02F 1/1337

(52) U.S. Cl. 349/123

(57) ABSTRACT

Provided are a method of printing an alignment layer of a liquid crystal display and an alignment layer printing apparatus for performing the method. The method includes disposing a mother plate on a stage and aligning a plurality of heads with a one side surface of the stage. Each head comprises a plurality of nozzles to eject alignment solution. The method further includes inspecting an ejection of alignment solution ejected from the nozzles by operating the heads for a predetermined time, and if non-ejection of alignment solution from one of the nozzles is detected, circulating the alignment solution in the heads.

### CROSS REFERENCE TO RELATED APPLICATION

This application claims priority from and the benefit of Korean Patent Application No. 10-2006-0099525, filed on Oct. 12, 2006, which is hereby incorporated by reference for all purposes as if fully set forth herein.

### BACKGROUND OF THE INVENTION

1. Field of the Invention

The present invention relates to a method of printing an alignment layer of a liquid crystal display (LCD) and an alignment layer printing apparatus for performing the method. More particularly, the present invention relates to a method of printing an alignment layer of an LCD, in which non-ejection of an alignment solution may be detected and then eliminated, and an alignment layer printing apparatus for performing the method.

2. Discussion of the Background

Recently, liquid crystal displays (LCDs) have been increasingly used as display devices. LCDs display images formed using the electrical and optical properties of liquid crystal molecules injected into a liquid crystal panel and have been widely applied to various devices, including computer monitors and mobile communication terminals, due to their compactness, lightness, and low power consumption.

LCDs may be manufactured through a number of processes. In general, an LCD fabrication method includes a thin film transistor (TFT) substrate forming process, a common electrode substrate forming process, a liquid crystal cell process in which a TFT substrate and a common electrode substrate are coupled to each other and liquid crystal molecules are injected into a space there between to form a liquid crystal panel, and a module combining process in which the liquid crystal panel and other modules are combined together.

Here, an alignment layer printing process may be performed on a pixel electrode of a TFT substrate and a common electrode of a common electrode substrate that have been previously manufactured. Alignment layers may be formed using a polymer material. In order to uniformly coat alignment layers on a TFT substrate and a common electrode substrate, an alignment layer printing apparatus is needed. Recently, an alignment layer printing apparatus using an inkjet head has been employed.

An alignment layer printing apparatus using inkjet technology may include a plurality of heads including nozzles for ejecting alignment solution and an alignment solution supplier for supplying alignment solution to the heads. Such an alignment layer printing apparatus ejects alignment solution through the nozzles onto the entire surface of a TFT substrate or a common electrode substrate to form alignment layers.

However, in the above-described inkjet-based alignment layer printing apparatus and method, an ejection failure, meaning the non-ejection of alignment solution, may occur due to the generation of bubbles in one of the heads and/or nozzles. When an ejection failure occurs while printing an alignment layer, streak-like stains may appear on the TFT substrate or the common electrode substrate, resulting in a defective LCD.

### SUMMARY OF THE INVENTION

The present invention provides a method of printing an alignment layer of an LCD, in which the non-ejection of alignment solution may be detected and then eliminated.

The present invention also provides an alignment layer printing apparatus that performs the above method.

Additional features of the invention will be set forth in the description which follows, and in part will be apparent from the description, or may be learned by practice of the invention.

The present invention discloses a method of printing an alignment layer of an LCD including disposing a mother plate on a stage and aligning a plurality of heads with a side surface of the stage. Each head includes a plurality of nozzles to eject alignment solution. The method further includes inspecting an ejection of alignment solution from the nozzles by operating the heads for a predetermined time and, if non-ejection of alignment solution from one of the nozzles is detected, circulating the alignment solution in the heads.

The present invention also discloses an apparatus for printing an alignment layer of an LCD including a stage on which a mother plate is disposed and a plurality of heads disposed above the mother plate. Each head includes a plurality of nozzles to eject alignment solution. The apparatus further includes an alignment solution circulation system to inspect an ejection of alignment solution and to remove bubbles generated in the heads by circulating the alignment solution in the heads.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a flow diagram showing a method of manufacturing a liquid crystal display, including an alignment layer printing process, according to an exemplary embodiment of the present invention.

FIG. 2 is a flow diagram showing an alignment layer printing process according to an exemplary embodiment of the present invention.

FIG. 3 is a view showing an alignment layer printing apparatus according to an exemplary embodiment of the present invention.

FIG. 4 is a flow diagram showing an alignment solution circulation process that is executed by the alignment layer printing apparatus of FIG. 3.

FIG. 5 is a view of part A of FIG. 3.

FIG. 6 is a perspective view of the alignment layer printing apparatus shown in FIG. 3.

FIG. 7 is a bottom perspective view of a head of the alignment layer printing apparatus shown in FIG. 6.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as being limited to the exemplary embodiments set forth herein. Rather, these exemplary embodiments are provided so that this disclosure will be thorough and complete, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layer may be present. In contrast, when an element is referred to as being “directly on” or “directly connected to” another element or layer, there are no intervening elements or layers present.

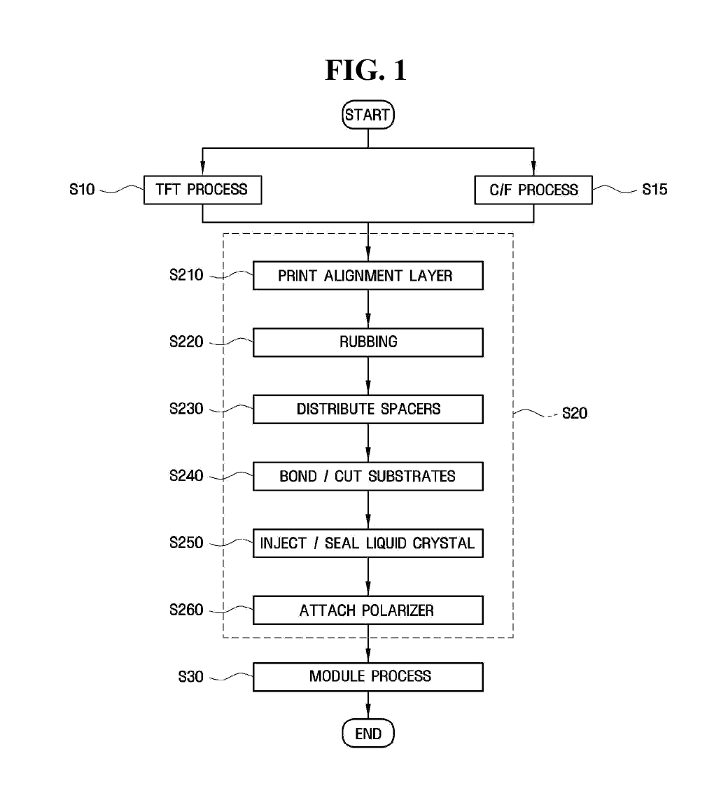

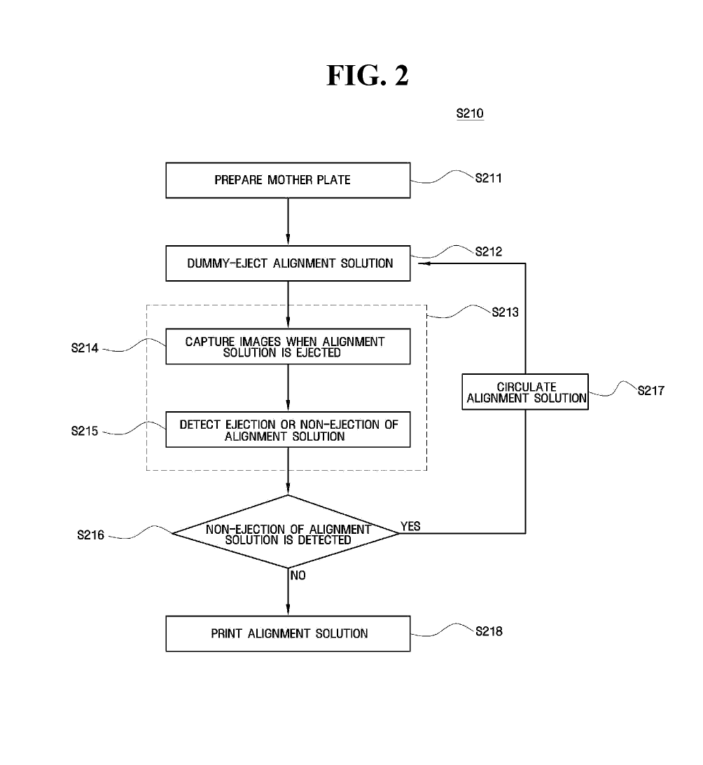

FIG. 1 is a flow diagram showing a method of manufacturing a LCD, including an alignment layer printing process, according to an exemplary embodiment of the present invention, and FIG. 2 is a flow diagram showing an alignment layer printing process according to an exemplary embodiment of the present invention.

First, referring to FIG. 1, an LCD manufacturing method may include a thin film transistor (TFT) process S10 for manufacturing a TFT mother plate from which a plurality of TFT substrates are formed, a C/F process S15 for manufacturing a common electrode mother plate from which a plurality of common electrode substrates are formed, and a liquid crystal cell process S20 for manufacturing liquid crystal panels by assembling the TFT mother plate and the common electrode mother plate manufactured using the TFT process S110 and the C/F process S15, respectively. An LCD manufacturing method my further include cutting the resultant mother plate assembly into unit cells and injecting liquid crystals into the unit cells and a module process S30 for combining the liquid crystal panels manufactured during the liquid crystal cell process S20 with other modules to form complete LCDs.

Each above-described process may include more detailed processes. For example, the TFT process S10 may include steps similar to those performed in a silicon semiconductor fabrication process, such as thin film formation, deposition, photolithography, and etching, as well as inspection and cleaning processes before and after each step.

The liquid crystal cell process S20 may include more unit processes. For example, the liquid crystal cell process S20 may include printing alignment layers S210, rubbing the alignment layers S220, distributing spacers on the rubbed alignment layers S230, assembling the TFT mother plate and the common electrode mother plate and cutting the resultant mother plate assembly into predetermined sizes S240, injecting liquid crystal molecules into a gap between the two substrates and sealing unit cells S250, and attaching polarization plates to the unit cells S260.

The alignment layer printing process S210 may be performed on pixel electrodes and common electrodes of two mother plates, i.e., the TFT mother plate and the common electrode mother plate, manufactured through the TFT process S110 and the common electrode process S15. Here, alignment layers may adhere well to surfaces made of indium tin oxide (ITO) or indium zinc oxide (IZO), have a uniform film thickness of 1,000 Å or less at 200° C. or less, and have high electrical and chemical stability. In view of these provisions, the alignment layers may be made of a polymer, e.g., polyimide, a polyimide-based compound, polyvinyl alcohol, or polyamic acid, but the present invention is not limited thereto.

The alignment layer printing process S210 will be described in detail below with reference to FIG. 2.

Referring to FIG. 2, the alignment layer printing process S210 may include preparing a mother plate S211, dummy-ejecting alignment solution S212, inspecting the dummy-ejection of alignment solution S213, and determining whether or not non-ejection of alignment solution has occurred S216. After determining whether or not non-ejection of alignment solution has occurred S216, the alignment layer printing process S210 may further include printing the alignment solution S218 or circulating the alignment solution S217.

In detail, first, in the preparation of the mother plate S211, the mother plate may be disposed on a stage (not shown) of an alignment layer printing apparatus (not shown) as will be described below. Here, the mother plate may be coupled to the stage using, e.g., a vacuum/adsorption method.

Next, an alignment solution may be dummy-ejected on predetermined regions of the stage of the alignment layer printing apparatus S212 where the mother plate is not located. The alignment layer printing apparatus may include a plurality of heads (not shown). A plurality of nozzles (not shown) may be formed at a lower side of each head. A predetermined volume of the alignment solution may be ejected through the nozzles.

Next, the dummy-ejection of alignment solution may be inspected S213. In detail, when the alignment solution is supposed to be ejected from the nozzles, images are captured S214 and ejection or non-ejection of the alignment solution may be detected by analyzing the captured images S215. In order to capture the images, the alignment layer printing apparatus may further include a plurality of charge-coupled device (CCD) cameras (not shown) disposed adjacent to the heads. By using the CCD cameras, it may be possible to capture images when the alignment solution is ejected from the nozzles.

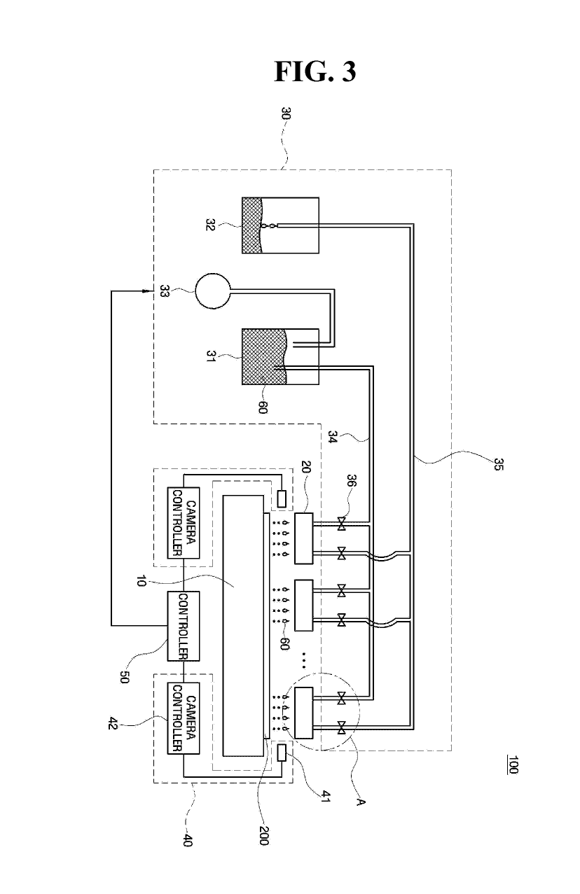

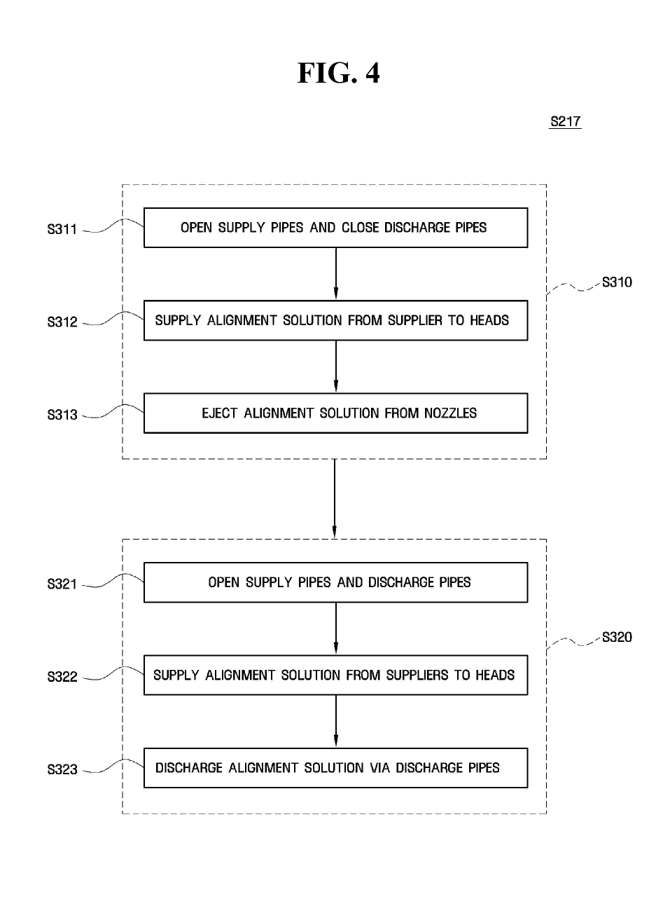

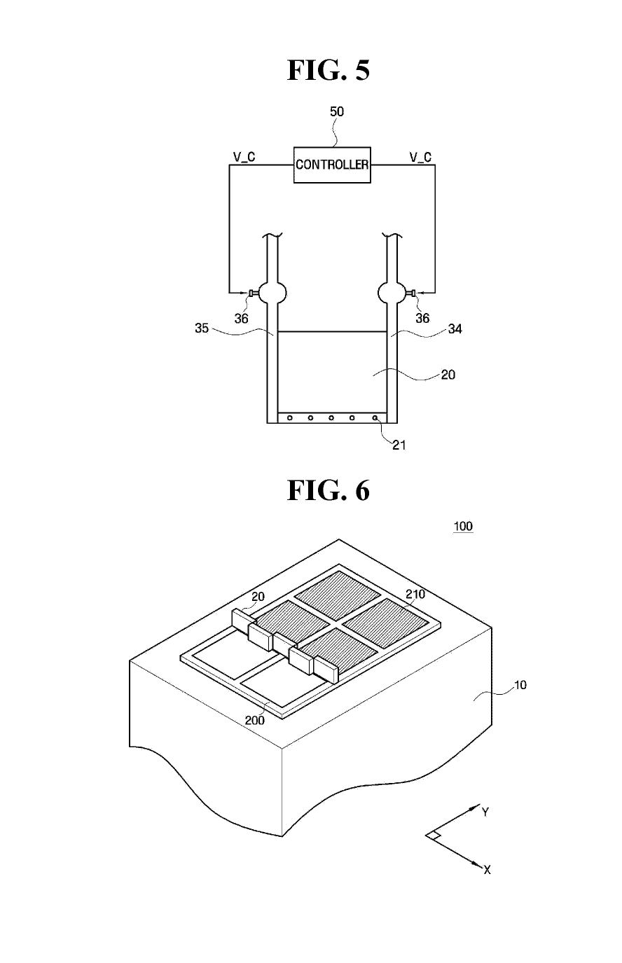

After inspecting the ejection of alignment solution S213, a determination is made as to whether or not non-ejection of alignment solution has occurred S216. In detail, when inspecting the ejection of alignment solution S213, if non-ejection of the alignment solution is detected from one of the nozzles, the alignment layer printing apparatus circulates the alignment solution to the heads to repair the non-ejecting nozzle S217. Circulating the alignment solution S217 forcibly may remove bubbles generated in the nozzles or heads and thus, eliminate the occurrence of non-ejections of alignment solution. The circulation of the alignment solution S217 will be described below in detail with reference to FIG. 3, FIG. 4, and FIG. 5.

After circulating the alignment solution (S217), another dummy-ejection of alignment solution is made on predetermined regions of the stage of the alignment layer printing apparatus S212 and the subsequent processes S213 and S216 are repeated. The circulation of the alignment solution S217, the dummy-ejection of alignment solution S212, and the inspection of the ejection of alignment solution S213 may be repeatedly performed until no non-ejections of alignment solution are detected.

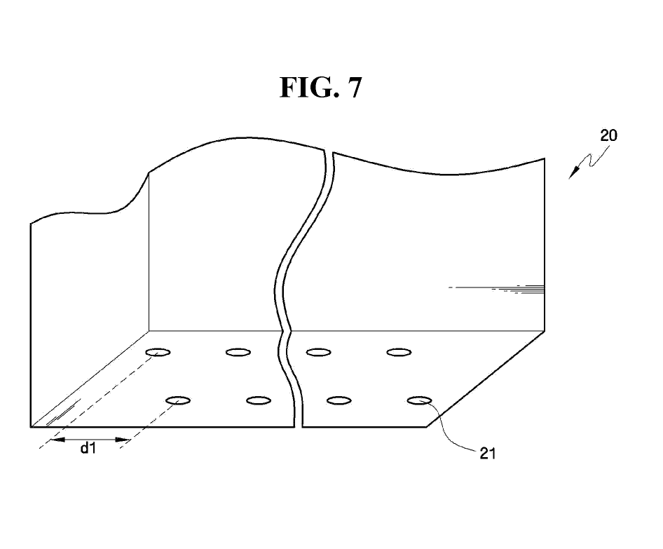

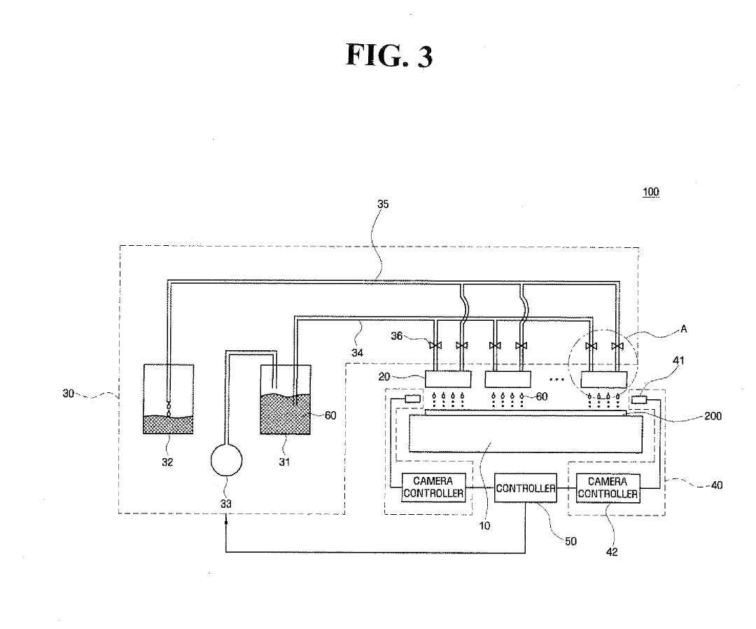

After inspection of the ejection of alignment solution S213, if non-ejection of alignment solution is not detected, the alignment solution may be printed on surface the mother plate disposed on the stage of the alignment layer printing apparatus S218. The printing of the alignment solution S218 will be described below in detail with reference to FIG. 6 and FIG. 7.

Referring again to FIG. 1, after printing the alignment layers S210 as described above, the alignment layers are rubbed in a predetermined direction S220. For example, the rubbing may be performed using a cotton- or nylon-planted soft cloth. By doing so, liquid crystal molecules interposed between the two mother plates may be arranged in a predetermined direction on surfaces of the alignment layers during the liquid crystal injection and sealing process S250 as will be described below.

Next, spacers are distributed on the rubbed alignment layers S230. The spacers may maintain a uniform distance between the TFT mother plate and the common electrode mother plate.

Then, the TFT mother plate and the common electrode mother plate are assembled, and the resultant mother plate assembly is cut into predetermined sections, e.g., into unit liquid crystal cells S240.

The two mother plates may be assembled using seal patterns made of a sealant. The seal patterns may be formed on the TFT mother plate and/or the common electrode mother plate using a sealant to form pouches for the injection of liquid crystal molecules, as will be described below.

The mother plate assembly obtained by assembling the two mother plates, using the seal patterns as described above, is cut into unit liquid crystal cells. The cutting of the mother plate assembly may be performed using a scribing process to form cutting lines on a glass surface with a diamond pen and a breaking process to cut the mother plate assembly under an impact force, but the present invention is not limited thereto.

Next, liquid crystal molecules may be injected into the liquid crystal panels, i.e., into spaces between TFT substrates and common electrode substrates constituting liquid crystal panels, and sealed so that the liquid crystal molecules do not leak S250, thus forming liquid crystal cells. A vacuum injection method may be used for injection of the liquid crystal molecules. For example, gaps between TFT substrates and common electrode substrates may be evacuated, and liquid crystal molecules may then be injected into the gaps using the pressure difference created between the gaps and the surrounding atmosphere.

Polarization plates may be respectively attached to both surfaces (top and bottom) of the liquid crystal panels after the injection of liquid crystal molecules S260. Normal liquid crystal panels may be selected using an electrical and optical performance test and polarization plates may be attached to the normal liquid crystal panels.

As described above, the liquid crystal panels completed after the liquid crystal cell process S20 may be subjected to the module process S30. The module process S30 may include mounting driving integrated circuits (ICs) on the liquid crystal panels, attaching printed circuit boards (PCBs) to the liquid crystal panels, and assembling the liquid crystal panels with backlight units and chassis.

LCD completed after the module process S30 may include liquid crystal panels, backlight units, chassis, and driving IC units. The LCDs may be inspected for shipment, for example, through an aging test, prior to distribution in the market.

Hereinafter, the above-described alignment layer printing process will be described in more detail with reference to FIG. 3, FIG. 4, and FIG. 5.

FIG. 3 is a view showing an alignment layer printing apparatus according to an exemplary embodiment of the present invention; FIG. 4 is a flow diagram showing an alignment solution circulation process that is executed by the alignment layer printing apparatus in FIG. 3, and FIG. 5 is a view of part A of FIG. 3.

First, referring to FIG. 3, an alignment layer printing apparatus 100 according to an exemplary embodiment of the present invention may include a stage 10, a plurality of heads 20, and an alignment solution circulation system. For example, the alignment solution circulation system may include a storage unit 30, an inspection unit 40, and a controller 50.

A mother plate 200 (e.g., a TFT mother plate and/or a common electrode mother plate manufactured using the above-described TFT process (see S10 of FIG. 1) and/or the C/F process (see S15 of FIG. 1), respectively may be disposed and/or immobilized on the stage 10. The mother plate 200 may be disposed and/or immobilized on the stage 10 using, for example, a vacuum/adsorption method.

The heads 20 may be arranged above the mother plate 200 disposed on the stage 10, and a plurality of nozzles (not shown) may be formed at a lower side of each head 20. The heads 20 may be arranged, for example, in a zig-zag pattern above the mother plate 200. The heads 20 may include a piezoelectric portion (not shown) configured to adjust the ejection of alignment solution 60 by controlling the nozzles.

As stated above, the alignment solution circulation system includes the storage unit 30, the inspection unit 40, and the controller 50. The storage unit 30 may include a supplier 31, a receiver 32, and a pressurizer 33. The supplier 31 stores the alignment solution 60 and supplies the alignment solution 60 to the heads 20 via a plurality of supply pipes 34 connected to the heads 20. Here, the alignment solution 60 may be stored under a predetermined pressure and then supplied to the heads 20 via the supply pipes 34.

In detail, the supplier 31 may be connected to the pressurizer 33 and may receive a gas, e.g., nitrogen (N₂) gas, from the pressurizer 33. The alignment solution 60 stored in the supplier 31 may be stored under a predetermined pressure by nitrogen gas supplied from the pressurizer 33, and the pressurized alignment solution 60 may be supplied to the heads 20 via the supply pipes 34. The alignment solution 60 may be stored under a pressure of about 0.05 to 1.00 MPa.

The receiver 32 receives the alignment solution remaining after ejection via a plurality of discharge pipes 35 connected to the heads 20 and stores the received alignment solution. The received alignment solution may be transferred back to the supplier 31 from the receiver 32. Valves 36 for opening or closing the supply pipes 34 and the discharge pipes 35 may be installed at the supply pipes 34 and the discharge pipes 35, respectively.

The inspection unit 40 may include a plurality of CCD cameras 41 and a plurality of camera controllers 42. For example, the CCD cameras 41 may be disposed adjacent to the heads 20, respectively.

The CCD cameras 41 may be used to detect whether or not alignment solution 60 is ejected from the nozzles of the heads 20. In detail, as described above with reference to FIG. 2, the CCD cameras 41 may capture images when alignment solution 60 is supposed to be ejected from the nozzles of the heads 20 and may supply the captured images to the camera controllers 42.

The camera controllers 42 control the operation of the CCD cameras 41 and analyze the images (i.e., the images captured when alignment solution 60 is supposed to be ejected) supplied from the CCD cameras 41 to determine whether or not alignment solution 60 is being ejected. Here, inspection information about ejection of alignment solution 60 may be supplied to the controller 50.

The controller 50 determines whether the alignment solution 60 is to be printed or circulated according to the inspection information supplied by the inspection unit 40, and accordingly, controls the storage unit 30. In detail, when non-ejection of alignment solution 60 is detected by the inspection unit 40, the controller 50 controls the storage unit 30 so that circulation of the alignment solution 60 in the heads 20 is performed. The circulation of alignment solution 60 may include more detailed processes.

The above-described alignment solution circulation process will be described in detail below with reference to FIG. 4 and FIG. 5.

First, referring to FIG. 4, an alignment solution circulation process S217 may include removing bubbles generated in a plurality of nozzles S310 and removing bubbles generated in a plurality of heads S320. Each bubble removal process S310 and S320 may include more detailed processes.

Removing bubbles generated in a plurality of nozzles S310 may include controlling valves so that supply pipes 34 are open and discharge pipes 35 are closed S311, supplying alignment solution from the supplier 31 to a plurality of heads S312, and ejecting alignment solution from a plurality of nozzles S313.

The removal of bubbles generated in a plurality of nozzles S310 will be described in detail below with reference to FIG. 3, FIG. 4, and FIG. 5.

Referring to FIG. 3, FIG. 4, and FIG. 5, first, when non-ejection of the alignment solution 60 is detected by the inspection unit 40, the controller 50 supplies a control signal, e.g., a valve control signal V_C, to the storage unit 30. Thus, the storage unit 30 opens the valves 36 of the supply pipes 34 that are connected to the heads 20, respectively, and closes the valves 36 of the discharge pipes 35 S311. At this time, the controller 50 may control the storage unit 30 so that the supply pipes 34 remain open for about 0.5 to 3 seconds.

Next, the heads 20 receive alignment solution 60 from the supplier 31 via the supply pipes 34 opened by the controller 50 S312. Alignment solution 60 may be supplied to the heads 20 under a predetermined pressure (e.g., 0.05-1.00 MPa) by the pressurizer 33.

Next, the heads 20 eject alignment solution 60 from a plurality of nozzles 21 S313. By doing so, the bubbles generated in the nozzles 21 may be removed simultaneously with the ejection of the alignment solution 60.

Referring again to FIG. 4, the removal of bubbles generated in a plurality of the heads S320 may include controlling valves so that supply pipes 34 and discharge pipes 35 are open S321, supplying alignment solution from the supplier 31 to a plurality of heads S322, and discharging alignment solution via the discharge pipes S323.

The removal of bubbles generated in a plurality of the heads S320 will be described in detail below with reference to FIG. 3, FIG. 4, and FIG. 5.

Referring to FIG. 3, FIG. 4, and FIG. 5, first, when non-ejection of alignment solution 60 is detected by the inspection unit 40, the controller 50 supplies a control signal, e.g., a valve control signal V_C, to the storage unit 30. Thus, the storage unit 30 opens the valves 36 of the supply pipes 34 and the discharge pipes 35 connected to the heads 20 S321. At this time, the controller 50 may control the storage unit 30 so that the supply pipes 34 and the discharge pipes 35 remain open for about 1-6 seconds.

Next, the heads 20 receive alignment solution 60 from the supplier 31 via the supply pipes 34 S322. At this time, the alignment solution 60 may be supplied to the heads 20 under a predetermined pressure (e.g., 0.05-1.00 MPa) by the pressurizer 33.

Next, the alignment solution 60 supplied to the heads 20 is discharged, e.g., to the receiver 32, via the discharge pipes 35 S323. The bubbles generated in the heads 20 may be removed by circulating the alignment solution 60, that is, by circulating the alignment solution 60 from the supply pipes 34 to the discharge pipes 35 via the heads 20.

Referring again to FIG. 4, in the removal of bubbles generated in a plurality of the heads 20 S320, after discharging the alignment solution from the heads 20, e.g., to the receiver 32, via the discharge pipes 35 S323, the removal of bubbles generated in a plurality of the nozzles 21 S310 may be performed. By doing so, bubbles that may be generated (e.g., bubbles that may be generated in the nozzles 21) while the alignment solution is being supplied from the supplier 31 to the heads via the supply pipes 34 (S322) may be removed, thereby eliminating non-ejections of alignment solution.

Thus far, an alignment solution circulation process according to an exemplary embodiment of the present invention has been described with reference to FIG. 3, FIG. 4, and FIG. 5. The present exemplary embodiment has shown an alignment solution circulation process including sequential execution of the removal of bubbles in nozzles 21 and the removal of bubbles in heads 20, but the present invention is not limited thereto. In an alignment solution circulation process according to the present invention, the removal of bubbles in heads 20 may be performed before the removal of bubbles in nozzles 21. Alternatively, the removal of bubbles in nozzles 21 and the removal of bubbles in heads 20 may be performed simultaneously.

The alignment solution printing process of FIG. 2 will be described in detail with reference to FIG. 6 and FIG. 7.

FIG. 6 is a perspective view of the alignment layer printing apparatus in FIG. 3, and FIG. 7 is a bottom perspective view of a head of the alignment layer printing apparatus in FIG. 6.

First, referring to FIG. 6, an alignment layer printing apparatus 100 may include a stage 10 and a plurality of heads 20, as described above.

A mother plate 200 may be disposed on the stage 10. The mother plate 200 may be disposed and/or immobilized on the stage 10 using, e.g., a vacuum/adsorption method. Here, the mother plate 200 may include a plurality of TFT substrates and/or a plurality of common electrode substrates 210.

A plurality of heads 20 may be arranged above the mother plate 200, for example in a zig-zag pattern. Referring to FIG. 7, a plurality of nozzles 21 may be formed at a lower side of each head 20. The nozzles 21 may be arranged, e.g., in a zig-zag pattern, at a lower side of each head 20. The nozzles 21 may also be arranged at a nozzle pitch d1 (i.e., the distance between two adjacent nozzles 21) of about 730-760 μm.

Although not shown in FIG. 6, the alignment layer printing apparatus 100 may further include a controller, an inspection unit, and a storage unit.

The alignment layer printing apparatus 100 prints an alignment solution on the mother plate 200 disposed on the stage 10 when non-ejection of the alignment solution is not detected by the inspection unit, as described above with reference to FIG. 2.

In detail, the alignment layer printing apparatus 100 may perform an alignment solution printing process by aligning the heads 20 with the mother plate 200, e.g., with an upper surface of the mother plate 200, and ejecting alignment solution supplied from the storage unit onto the upper surface of the mother plate 200 via the nozzles 21.

The above-described alignment solution printing process will be described in more detail below with reference to FIG. 2, FIG. 6, and FIG. 7.

Referring to FIG. 2, FIG. 6, and FIG. 7, first, when non-ejection of an alignment solution is not detected by an inspection unit, a controller determines an alignment solution printing process to be performed. Thus, a plurality of heads 20, i.e., a plurality of heads 20 filled with alignment solution, is aligned with the upper surface of a mother plate 200 disposed on a stage 10 of an alignment layer printing apparatus 100.

Next, the alignment layer printing apparatus 100 moves the stage 10 in a first direction of the mother plate 200, e.g., in a Y direction. At this time, the alignment layer printing apparatus 100 prints the alignment solution from a first side to a second side, e.g., in the longitudinal direction of the mother plate 200, via a plurality of nozzles 21 formed in the heads 20. Alignment solution may be printed only on a plurality of TFT substrates and/or common electrode substrates 210 constituting the mother plate 200.

Next, the alignment layer printing apparatus 100 moves the heads 20 in a second direction, e.g., in an X direction. The heads 20 may be moved in the second direction by at least ½ of a nozzle pitch d1, i.e., the distance between two adjacent nozzles 21.

Then, the alignment layer printing apparatus 100 moves the stage 10 in an direction opposite the first direction of the mother plate 200, e.g., in a −Y direction. At this time, the alignment layer printing apparatus 100 prints the alignment solution from the second side to the first side, e.g., in the longitudinal direction (as viewed in FIG. 6) of the mother plate 200 via the nozzles 21 formed at the heads 20. The alignment solution may be printed only on the TFT substrates and/or common electrode substrates 210 constituting the mother plate 200.

The above-described alignment solution printing process S218 may be repeatedly performed on the mother plate 200. In detail, the alignment layer printing apparatus 100 may print alignment solution by gradually moving the heads 20 in a second direction by ½ or less, more preferably ¼, of a nozzle pitch while repeatedly moving the stage 10 in a first direction, e.g., in a Y or −Y direction. By doing so, alignment solution may be uniformly ejected onto the mother plate 200, thereby forming alignment layers with uniform thickness.

As described above, according to a method and apparatus for printing an alignment layer of an LCD of the present invention, non-ejection of an alignment solution due to bubbles generated in heads or nozzles may be detected, and the bubbles generated in the heads or nozzles may be removed, thereby reducing defects due to non-ejection of alignment solution. Moreover, the detection of non-ejection of alignment solution due to bubbles and the removal of the bubbles may be performed during an alignment layer printing process, thereby reducing process duration and manufacturing costs.

It will be apparent to those skilled in the art that various modifications and variations can be made in the present invention without departing from the spirit or scope of the invention. Thus, it is intended that the present invention cover the modifications and variations of this invention provided they come within the scope for the appended claims and their equivalents.

What is claimed is:

1. A method of printing an alignment layer of a liquid crystal display, the method comprising:
disposing a mother plate on a stage;
aligning a plurality of heads, each head comprising a plurality of nozzles to eject alignment solution, with a side surface of the stage;
inspecting an ejection of alignment solution from the nozzles while operating the heads for a predetermined time; and
circulating the alignment solution in the heads if non-ejection of alignment solution from at least one of the nozzles is detected.

2. The method of claim 1, wherein circulating the alignment solution comprises:
supplying alignment solution to the heads and ejecting alignment solution from the nozzles; and
supplying alignment solution to the heads and discharging alignment solution from the heads.

3. The method of claim 2, wherein the heads are connected to supply pipes to receive alignment solution from an external source and to discharge pipes to discharge alignment solution passed through the heads,
wherein supplying alignment solution to the heads and ejecting alignment solution from the nozzles comprises:
supplying alignment solution to the heads from the external source via the supply pipes while the discharge pipes are closed, and
ejecting alignment solution from the nozzles.

4. The method of claim 3, the alignment solution is supplied to the heads via the supply pipes for about 0.5-3 seconds.

5. The method of claim 2, wherein the heads are connected to supply pipes for to receive the alignment solution from an external source and to discharge pipes to discharge the alignment solution passed through the heads, and
wherein supplying alignment solution to the heads and discharging alignment solution from the heads comprises:
supplying alignment solution to the heads from the external source via the supply pipes while the discharge pipes are open, and
discharging alignment solution from the heads.

6. The method of claim 5, wherein
the alignment solution is discharged from the heads for about 1-6 seconds.

7. The method of claim 5, further comprising:
after discharging alignment solution from the heads, supplying alignment solution to the heads from the external source via the supply pipes while the discharge pipes are closed; and
ejecting alignment solution from the nozzles.

8. The method of claim 1, wherein the alignment solution in the heads is kept under a pressure of about 0.05-1.00 MPa.

9. The method of claim 8, wherein the alignment solution is kept under nitrogen (N₂) gas atmosphere.

10. The method of claim 1, further comprising:
after circulating the solution, inspecting the ejection of alignment solution from the nozzles by operating the heads again.

11. The method of claim 1, wherein inspecting the ejection of the alignment solution comprises:
ejecting alignment solution from the nozzles by operating the heads for about 1-2 seconds;
capturing images with charge-coupled device cameras disposed adjacent to the heads when alignment solution is supposed to be ejected from the nozzles; and
determining whether or not ejection of alignment solution has occurred based on the captured images.

12. The method of claim 11, further comprising:
aligning the heads with the mother plate when non-ejection of alignment solution from the nozzles is not detected; and
printing alignment solution on an upper surface of the mother plate via the nozzles.

13. The method of claim 12, wherein printing alignment solution comprises:
printing alignment solution on the mother plate from a first side to a second side of the mother plate via the nozzles by moving a stage on which the mother plate is placed in a first direction;
moving the heads in a second direction perpendicular to the first direction; and
printing alignment solution on the mother plate from the second side to the first side of the mother plate via the nozzles by moving the stage in a direction opposite to the first direction.

14. The method of claim 13, wherein the nozzles are arranged in each head at a nozzle pitch of about 730-760 μm, and each head is moved a distance in the second direction of ½ or less of the nozzle pitch.

15. An apparatus for printing an alignment layer of a liquid crystal display, the apparatus comprising:
a stage to accommodate a mother plate;
a plurality of heads disposed above the stage, each head comprising a plurality of nozzles to eject alignment solution; and
an alignment solution circulation system to inspect an ejection or non-ejection state of alignment solution and to circulate alignment solution in the heads.

16. The apparatus of claim 15, wherein the alignment solution circulation system comprises:
a storage unit comprising a supplier to supply alignment solution to the heads via supply pipes connected to the heads, a receiver to receive alignment solution from the heads via discharge pipes connected to the heads, and a pressurizer to keep the alignment solution stored in the supplier under pressure;
an inspection unit to inspect the ejection or non-ejection state of alignment solution from the nozzles; and
a controller to control the storage unit and the inspection unit.

17. The apparatus of claim 16, wherein the inspection unit comprises charge-coupled device cameras respectively disposed adjacent to the heads to detect non-ejection of alignment solution.

18. The apparatus of claim 16, wherein the storage unit further comprises valves to control the supply pipes and the discharge pipes connected to the heads respectively, and
wherein the controller adjusts the time for which alignment solution is supplied to or discharged from the heads by opening or closing the valves.

19. The apparatus of claim 16, wherein the pressurizer keeps the alignment solution in the heads under a pressure of about 0.05-1.00 MPa.

20. The apparatus of claim 19, wherein the pressurizer keeps the alignment solution under nitrogen (N₂) gas atmosphere.
